(19) United States
(12) Patent Application Publication
(10) Pub. No.: US 2008/0314924 A1
(43) Pub. Date: Dec. 25, 2008

(54) DRIP CATCHING DEVICE

(75) Inventors: Gunter Marr, Rosengarten (DE); Peter Moeller, Franklin, TN (US); Karsten Schnoring, Hurth (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: MAPA GmbH Gummi-und Plastikwerke, Zeven (DE)

(21) Appl. No.: 12/118,175

(22) Filed: May 9, 2008

(30) Foreign Application Priority Data
Jun. 23, 2007 (DE) 20 2007 008 791.8
Jul. 12, 2007 (DE) 20 2007 009 720.4

(51) Int. Cl. B67D 1/16; B65D 23/06; B65D 5/72

(52) U.S. Cl. 222/108; 222/571; 215/392

(57) ABSTRACT

Drip catching device for bottles with contents of all types comprising an annular body made of sponge which may be attached to the neck of a bottle.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a drip catching device for bottles with contents of all types.

The drip catching device according to the invention is intended to catch drips and/or small amounts of liquid which, after pouring out liquids from a bottle, drip down and/or run down the bottle. The drip catching device is used, in particular, on red wine bottles or oil bottles in the home or in restaurants.

Drip protection rings are already known which have an annular body made of metal with a felt layer clamped inside. So that the drip protection ring may be pushed over the bead at the upper end of the bottle, its internal diameter is greater than the external diameter of the bead. As a result, the drip protection ring is loosely positioned on the neck so that, when pouring liquids out, it is able to move and inadequately catches liquids.

A further drip protection ring is known from DE 296 13 994, the entire contents of which is incorporated herein by reference, with an annular body made of high-grade steel which may be attached to the neck of the bottle and made of felt on the internal circumference. The annular body comprises annular parts which may be assembled radially by encasing the bottle neck and devices for fixing the annular parts to one another in an assembled arrangement. This makes it possible to clamp the drip protection ring to the neck of a bottle, so that during use it does not slip and the felt reliably catches liquid running down the neck.

The known drip catching devices are relatively costly. Liquid may drip down externally over the annular body without being absorbed by the felt. Additionally, the felt is not particularly absorbent. The felt possibly has to be replaced or cleaned in a costly manner.

Proceeding therefrom, the object of the invention is to provide a less costly drip catching device which reliably avoids liquid dripping down or running down from a bottle.

### BRIEF SUMMARY OF THE INVENTION

Advantageous embodiments of the drip catching device are provided in the sub-claims.

The drip catching device according to the invention for bottles with contents of all types comprises an annular body made of sponge which may be attached to the neck of a bottle.

The attachment of the drip catching device is very simple as, to this end, the annular body only has to be forced over the bead at the end of the bottle. Due to the resilience of the sponge, said annular body may be firmly clamped to the neck of the bottle, so that it does not slip and/or fall down. The sponge sucks up liquid dripping and/or running down from the bottle in a particularly reliable manner. In this connection, the amounts of liquid may be both smaller and larger as the sponge has a particularly large capacity for absorption. As the annular body does not require a metallic edge, liquid which comes into contact with the external circumference is soaked up. After the bottle has been completely emptied, the drip catching device may be used again, possibly after rinsing the annular body. Due to the low cost of the annular body, it is further provided to discard the annular body after use and to replace it with a new annular body.

The annular body may be produced from a natural or synthetic sponge. Preferably the annular body consists of a synthetic sponge and/or artificial sponge, which for example is produced by foaming polyvinyl alcohol (PVAL) and acetalating with formaldehyde to form polyvinyl formal. The sponge may also consist of different foamed synthetic materials, which have a capacity for absorbing the liquid to be absorbed.

According to a preferred embodiment, the annular body is a viscose sponge. The annular body is produced from material which is lubricated so that it is able to be slipped over the bead at the end of the bottle. The sponge may soak up approximately 20 times its own weight. A further advantage is the biodegradability, in particular of the viscose sponge.

The annular body, according to a preferred embodiment, has a hollow circular cylindrical shape which simplifies production on a large scale. For example, the annular bodies may be produced by cutting off a long hollow circular cylinder made of sponge.

Preferably, the internal diameter of the annular body is selected such that it may be clamped onto the neck of the bottle, which is intended to be provided with the drip catching device, for example onto the neck of red wine bottles or oil bottles. Large differences may be compensated by expansion when relatively small internal diameters are selected. According to an advantageous embodiment, the annular body has an internal diameter of 20 mm to 40 mm.

The external diameter of the annular body is preferably selected such that drips falling down may be caught and a certain amount of liquid is able to be collected. According to one embodiment, to this end the annular body has an external diameter ranging from 30 mm to 50 mm.

The height of the annular body is preferably such that said annular body is securely clamped to the neck of the bottle and the collection of a certain amount of liquid is ensured. To this end, the height of the annular body preferably ranges from 5 mm to 15 mm.

According to a further embodiment, the annular body has an internal diameter of 25 mm to 30 mm and/or an external diameter of 35 mm to 40 mm and/or a height of 7.5 mm to 12.5 mm.

According to a further embodiment, the annular body is arranged in a packet made of foldable flat material. This allows hygienic storage of the annular body before use. Moreover, the packet may be provided with information which relates to the use of the drip catching device. Moreover, it is possible to provide the packet with advertising, for example if the drip catching device is used as advertising means.

According to a further embodiment, the packet has a square bottom wall, side flaps articulated to two opposing longitudinal sides of the bottom wall which may be folded over the bottom wall and longitudinal flaps articulated to two further longitudinal sides of the bottom wall, which may be folded over the bottom wall and the side flaps, one of the longitudinal flaps having an insertion slot and the other of the longitudinal flaps having an insertion tongue which may be inserted into the insertion slot, when the longitudinal flaps are folded over the bottom wall and the side flaps. The drip catching device thus configured holds the annular body securely and protects it from the effects of the environment. The annular body may be easily removed, in order to be attached to the neck of a bottle. The packet is easily produced from foldable flat material.

According to a further embodiment, the side flaps and the longitudinal flaps of the packet are connected to the bottom wall via a short connecting web, the height thereof corresponding approximately to the height of the annular body. As a result, the annular body may be stored in the packet, without being excessively deformed.

According to a further embodiment, the packet is made of cardboard. The packet is able to be produced cost-effectively from cardboard and may be very easily printed.

According to a further embodiment, the packet has printed text on at least one external face. For example, information about the use of the drip catching device and or an advertising message may be printed.

### BRIEF DESCRIPTION OF THE SEVERAL VIEWS OF THE DRAWINGS

The invention is described in more detail hereinafter with reference to the accompanying drawings of an embodiment. In the drawings:

FIG. 1 shows the annular body of the drip catching device in a perspective view obliquely from the side;

FIG. 2 shows the annular body on a bottom wall of an opened packet located in a diminished perspective view obliquely from above;

FIG. 3 shows the closed packet in a perspective view obliquely from below.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

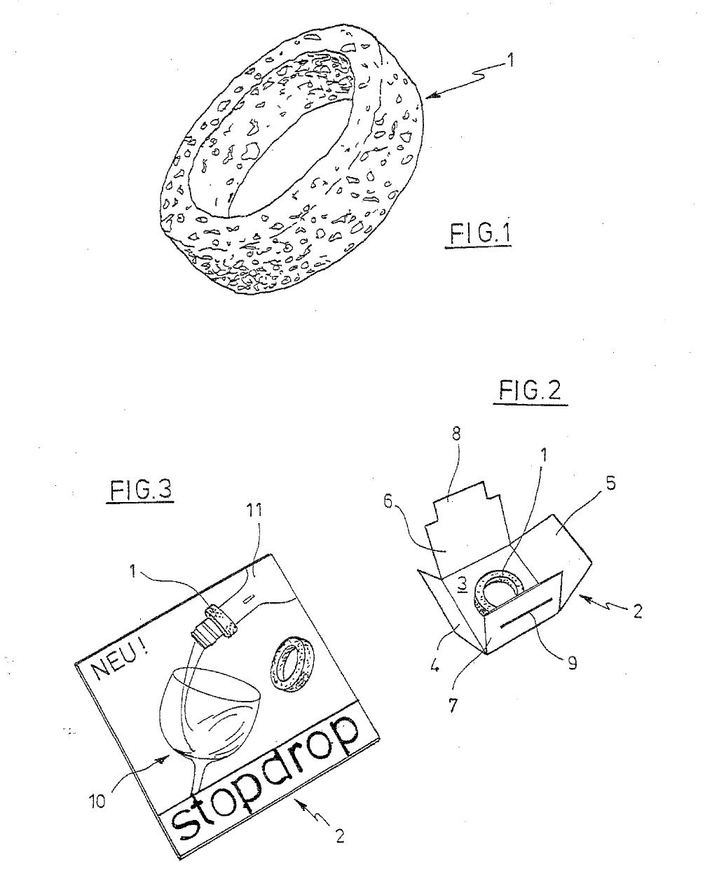

In FIG. 1 an annular body 1 of a drip catching device according to the invention is shown. The annular body 1 consists of viscose sponge. In this case it is a viscose-based foamed material.

The annular body 1 has, in the example, an internal diameter of approximately 28 mm, an external diameter of approximately 38 mm and a height of approximately 8 mm.

As a result, a red wine bottle is able to be slipped on and clamped at the neck beyond the bead at the end of the neck.

According to FIG. 2, a packet 2 for receiving the annular body 1 comprises a bottom wall 3 with side flaps 4, 5 on two opposing longitudinal sides and longitudinal flaps 6, 7 on two further longitudinal sides. The longitudinal flap 6 has an insertion tongue 8 and the longitudinal flap 7 comprises an insertion slot 9.

The packet 2 is closed by the side flaps 4, 5 being folded over the annular body 1 and subsequently the longitudinal flaps 6, 7 being folded over the side flaps 4, 5 and the insertion tongue 8 being inserted into the insertion slot 9.

The annular body 1 is accommodated securely and in a protected manner in the closed packet 2.

The bottom wall 3 has printed text 10 on the outer face which demonstrates the use of the annular body 1 on a wine bottle 11.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Drip catching device for bottles with contents of all types comprising an annular body (1) made of sponge which may be attached to the neck of a bottle.

2. Drip catching device according to claim 1, in which the annular body (1) is produced from a natural or synthetic sponge.

3. Drip catching device according to claim 2, in which the annular body (1) is a viscose sponge.

4. Drip catching device according to claim 1, in which the annular body (1) has a hollow circular cylindrical shape.

5. Drip catching device according to claim 1, in which the annular body (1) has an internal diameter of 20 mm to 40 mm and/or an external diameter of 30 mm to 50 mm and/or a height of 5 mm to 15 mm.

6. Drip catching device according to claim 5, in which the annular body (1) has an internal diameter of 25 mm to 30 mm and/or an external diameter of 35 mm to 40 mm and/or a height of 7.5 mm to 12.5 mm.

7. Drip catching device according to claim 1, in which the annular body (1) is arranged in a packet (2) made of foldable flat material.

8. Drip catching device according to claim 7, in which the packet (2) has a square bottom wall (3), side flaps (4, 5) articulated to two opposing longitudinal sides of the bottom wall which may be folded over the bottom wall (3) and longitudinal flaps (6, 7) articulated to two further longitudinal sides of the bottom wall, which may be folded over the bottom wall (3) and the side flaps (4, 5), one of the longitudinal flaps (6) having an insertion tongue (8) and the other of the longitudinal flaps (7) having an insertion slot (9), the insertion tongue (8) being able to be inserted into the insertion slot (9), when the longitudinal flaps (6, 7) are folded over the bottom wall (3) and the side flaps (4, 5).

9. Drip catching device according to claim 8, the side flaps (4, 5) and the longitudinal flaps (6, 7) being connected to the bottom wall via a short connecting web, the height thereof corresponding approximately to the height of the annular body (1).

10. Drip catching device according to claim 8, with a packet (2) made of cardboard.

11. Drip catching device according to claim 8, in which the packet (2) has printed text (10) on at least one external face.
